(19) United States
(12) Patent Application Publication
(10) Pub. No.: US 2006/0043227 A1
(43) Pub. Date: Mar. 2, 2006

(54) Reel and method of designing same

(76) Inventors: Wataru Iino, Kanagawa (JP); Ren Ishikawa, Kanagawa (JP)

Correspondence Address: TAIYO CORPORATION, 401 HOLLAND LANE, #407, ALEXANDRIA, VA, 22314, US

(21) Appl. No.: 11/198,151

(22) Filed: Aug. 8, 2005

(30) Foreign Application Priority Data
Sep. 1, 2004 (JP) 2004-253787
Sep. 21, 2004 (JP) 2004-274222

(51) Int. Cl. G11B 23/107

(52) U.S. Cl. 242/348; 242/613.1

(57) ABSTRACT

Disclosed are a reel structured such that a recording tape can be wound on a hub without interference with a pair of flanges provided in opposing relationship to each other, and a method of designing such a reel. The hub is formed in a tapered shape, and a taper angle of the hub is determined from an expression θ<sin⁻¹(G/L), where G is a spacing along an axial direction of the hub between the edge of the recording tape on the larger-diameter end portion of the hub at a winding start end of the recording tape and the flange on the larger-diameter side, and L is a winding length of the recording tape which is required to establish a state in which the recording tape can withstand a given tension when wound onto the hub.

### CROSS-REFERENCE TO RELATED APPLICATION

This application claims priority under 35 USC 119 from Japanese Patent Applications Nos. 2004-274,222 and 2004-253,787, the disclosures of which are incorporated by reference herein.

### BACKGROUND OF THE INVENTION

1. Field of the Invention

The present invention relates to a reel on which a recording tape such as a magnetic tape is wound and a method of designing such a reel.

2. Description of the Related Art

Known in the art, as an external recording medium for computers or the like, is a recording tape cartridge in which a reel having a magnetic tape, for example, wound thereon is accommodated in a case. The reel includes a hub which constitutes an axial center portion of the reel and on the outer circumference of which is wound the magnetic tape, and a pair of flanges which extend radially outward from axially opposite ends of the hub. When the magnetic tape is wound onto the reel, firstly, a fore end of the magnetic tape is wetted with water and adhered to the outer circumference of the hub (for example, refer to Japanese National Publication No. 63-501104). Subsequently, several turns of the magnetic tape is wound onto the hub under low tension, and when a state occurs in which the magnetic tape can withstand a predetermined tension, the tension and the winding speed are increased such that the magnetic tape is wound tightly onto the hub.

Meanwhile, it is often the case that a hub of a reel of the above-mentioned type is molded from a plastic material in the form of a bottomed cylindrical body which is opened at one axial end and closed at the other axial end. Such a hub is formed by a mold in which no gradient for the purpose of mold stripping (mold stripping taper) is set in order to secure the desired cylindricality of the outer circumference on which the magnetic tape is wound. However, it is likely that since the hub has a bottomed cylindrical shape, the open end portion becomes wider radially outward relative to the bottom portion, due to contraction after the mold stripping operation, and consequently the hub becomes formed in a tapered shape such that the opened end portion has a lager diameter than the closed end portion.

Further, the hub formed in such a bottomed cylindrical shape is likely to be deformed at the opened end portion, having a lower strength, due to the winding pressure of the magnetic tape. Such deformation of the hub tends to cause the flanges to be inclined toward the magnetic tape and thus to be placed into contact with the width-wise extremities (edges) of the magnetic tape.

Therefore, with a view to preventing hub deformation, a structure has been contemplated in which a hub is reinforced with a metallic ring-like member (for example, refer to JP-A No. 2004-14022) Moreover, a further structure has also been contemplated in which a hub is provided separately from a pair of flanges so as to prevent hub deformation from being transmitted to the flanges (for example, refer to U.S. Pat. No. 6,257,519(B1)).

As disclosed in Japanese National Publication No. 63-501104 referred to above, despite the fact that the hub has a tapered configuration, when the tension of the magnetic tape which is being wound onto the hub is high, the posture of the magnetic tape is rectified due to the tension and thus the magnetic tape is wound in a layered fashion (overlap wound) without being displaced widthwise. However, since the tension of the magnetic tape cannot be increased at an early winding stage, in which the magnetic tape is carried on the hub due to the adhesive force of water, there is a problem that the tapered configuration of the hub causes the magnetic tape to be wound spirally onto the outer circumference of the hub and thus contacted with the larger-diameter flange of the hub so as to be folded over.

On the other hand, in the structure of the above JP-A No. 2004-14022 in which a reinforcing member is provided, there is a concern that the number of parts and manufacturing cost are increased. Further, in the structure of U.S. Pat. No. 6,257,519, there is also a concern that the number of parts and manufacturing cost are increased due to the fact that it is a so-called three-piece structure, in which the hub and the respective flanges are molded as separate members, and then assembled together.

### SUMMARY OF THE INVENTION

The present invention has been made in view of the above circumstances and provides a reel in which recording tape can be wound up on a hub without interference with the flanges, and a method of designing such a reel. Also, the present invention has been made in view of the above circumstances and obtains a reel which does not increase the number of parts and yet prevents contact between the flanges and the recording tape.

A first aspect of the present invention provides a reel including a hub on which a recording tape is wound, and a radially outwardly extending flange provided on an axial end portion of the hub, wherein the hub is formed in a tapered shape in which an end portion on the flange side is larger in diameter than an opposite side end portion, and wherein the hub has a taper angle given by:
θ<sin⁻¹(G/L)
where G is a spacing along an axial direction of the hub between the flange side end portion at a winding start end of the recording tape and the flange; and L is a winding length of the recording tape which is required to establish a state in which the recording tape can withstand a given tension when wound on the hub.

A second aspect of the present invention provides a reel including a hub on which a recording tape is wound between a pair of flanges provided in opposing relationship with each other, wherein the hub has a taper angle given by:
θ<sin⁻¹(G/L)
where G is a spacing along an axial direction of the hub between a larger-diameter end portion of the hub at a winding start end of the recording tape with respect to the hub and one of the flanges which is provided on the larger-diameter side of the hub; and L is a winding length of the recording tape which is required to establish a state in which the recording tape can withstand a given tension when wound on the hub.

A third aspect of the present invention provides a method of designing a reel including a hub on which a recording tape is wound, and a radially outwardly extending flange provided on an axial end portion of the hub, wherein when the hub is structured in a tapered shape in which an end portion on the flange side is larger in diameter than an opposite side end portion, a taper angle of the hub is determined from:
θ<sin⁻¹(G/L)
where G is a spacing along an axial direction of the hub between the flange side end portion at a winding start end of the recording tape and the flange; and L is a winding length of the recording tape which is required to establish a state in which the recording tape can withstand a given tension when wound on the hub.

A fourth aspect of the present invention provides a method of designing a reel including a hub on which a recording tape is wound between a pair of flanges provided in opposing relationship with each other, wherein when the hub is formed in a tapered shape, a taper angle of the hub is determined from:
θ<sin⁻¹(G/L)
where G is a spacing along an axial direction of the hub between a larger-diameter end portion of the hub at a winding start end of the recording tape with respect to the hub and one of the flanges which is provided on the larger-diameter side of the hub; and L is a winding length of the recording tape which is required to establish a state in which the recording tape can withstand a given tension when wound on the hub.

A fifth aspect of the present invention provides a reel including a hub on which a recording tape is wound between a first and a second flange which are provided in opposing relationship with each other, the reel including: a first member in which the first flange is integrally provided on an axial end portion of the hub; and a second member in which the second flange is formed integrally with a fixed portion which is securely fixed to a portion other than the hub in the first member.

Other aspects, features and advantages of the present invention will become apparent from the following description taken in conjunction with the accompanying drawings.

### BRIEF DESCRIPTION OF THE DRAWINGS

Preferred embodiments of the present invention will be described in detail based on the following figures, in which:

FIG. 1 is a side view, partly cut away, showing a general structure of the reel according to a first embodiment of the present invention;

FIG. 2 is a side view showing a state when a magnetic tape begins to be wound onto the reel according to the first embodiment of the present invention;

FIG. 3 is a side view showing a state when the magnetic tape began to be wound onto the reel according to the first embodiment of the present invention;

FIG. 4 is a diagrammatic view illustrating a state in which a hub which constitutes the reel according to the first embodiment of the present invention is expanded out (opened up) into a plane for the purpose of explaining the method of calculating the taper angle of the hub;

FIG. 5 is a diagrammatic bottom view illustrating the difference in outer radius between an upper and a lower flange of the hub which constitutes the reel according to the first embodiment of the present invention;

FIG. 6 is a sectional view of a mold for forming by a resin molding process the hub which constitutes the reel according to the first embodiment of the present invention;

FIG. 7 is a perspective view showing a general structure of a recording tape cartridge to which is applied the reel according to the first embodiment of the present invention;

FIG. 8 is an exploded perspective view of the recording tape cartridge to which is applied the reel according to the first embodiment of the present invention;

FIG. 9 is a sectional view showing a general structure of the reel according to a second embodiment of the present invention;

FIG. 10 is an exploded sectional view of the reel according to the second embodiment of the present invention;

FIG. 11 is a sectional view showing a general structure of the reel according to a third embodiment of the present invention;

FIG. 12 is a sectional view showing a general structure of the reel according to a fourth embodiment of the present invention;

FIG. 13 is a sectional view of a general structure of the reel according to a fifth embodiment of the present invention.

### DETAILED DESCRIPTION OF THE INVENTION

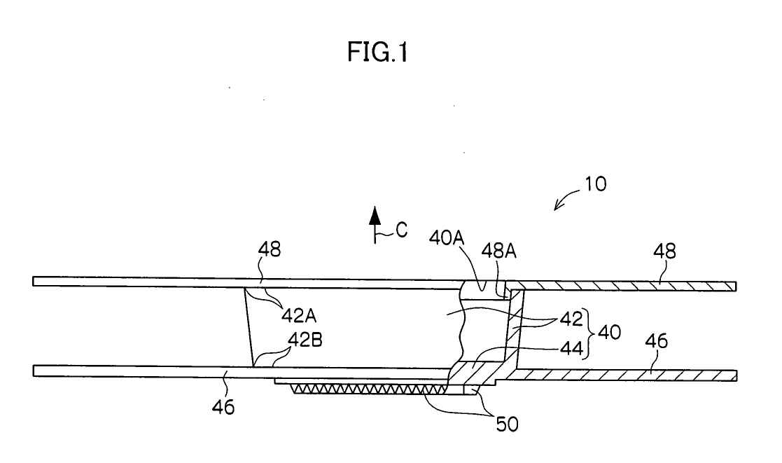

The reel 10 according to a first embodiment of the present invention will be described with reference to FIGS. 1 through 8. Firstly, description will be made of a general structure of a recording tape cartridge 12 to which the reel 10 is applied; secondly, description will be made of a general structure of the reel 10; and thirdly, explanation will be made of a taper angle θ of a hub 40 which constitutes a major portion of the present invention. Meanwhile, for the convenience of explanation, it is assumed that the direction that the recording tape cartridge 12 is loaded into a drive device as shown by an arrow A is the front direction (front side), and that arrows B and C orthogonal to the arrow A indicate the left direction and the upper direction, respectively

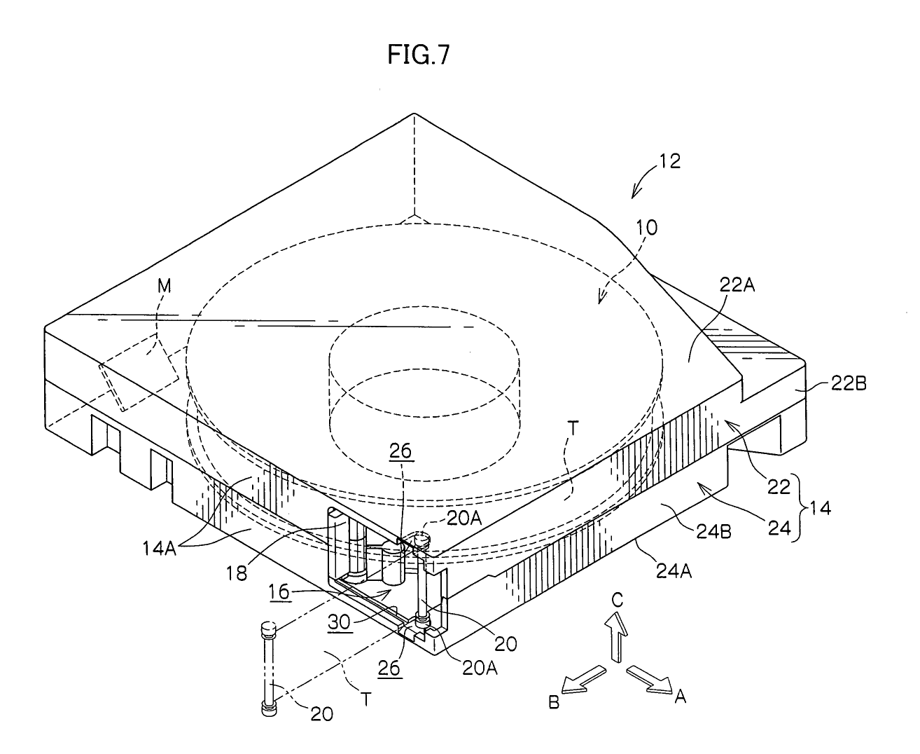

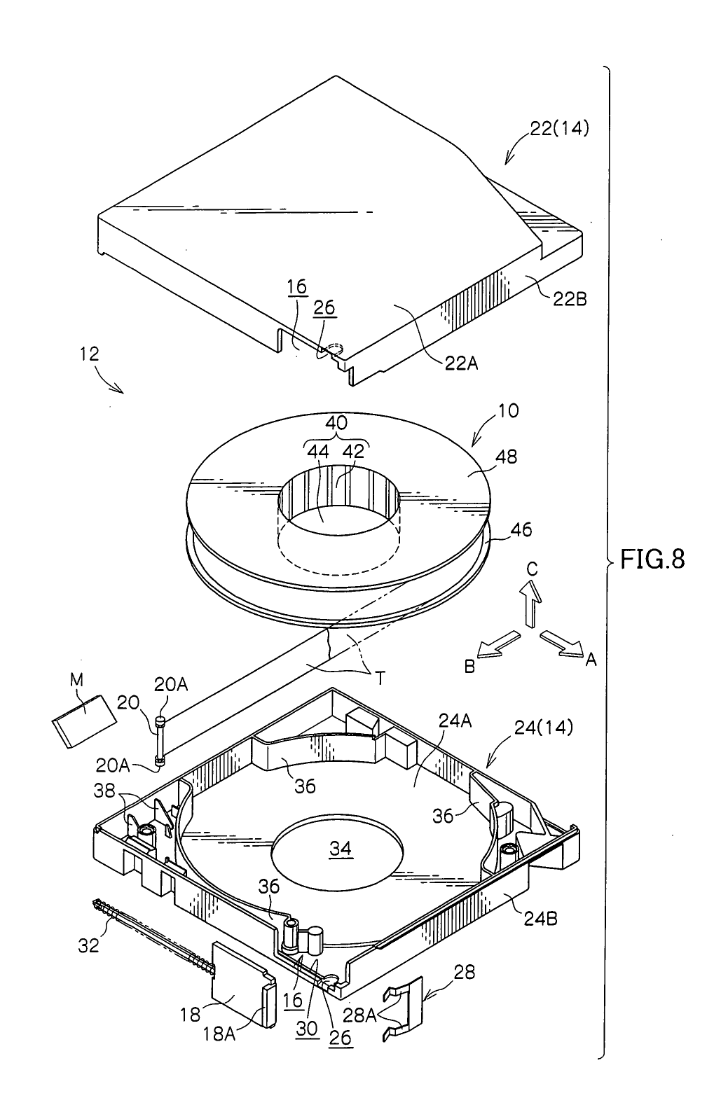

FIG. 7 is perspective view showing the general structure of the recording tape cartridge 12, and FIG. 8 is a schematic exploded perspective view showing the recording tape cartridge 12. As shown in these figures, the recording tape cartridge 12 is structured such that the single reel 10 on which a magnetic tape T as a recording tape, which is an information recording/reproducing medium, is wound is rotatably accommodated in a case 14 which is substantially rectangular as viewed in plan view.

In a front end portion of the right side wall of the case 14 is provided an opening 16 through which the magnetic tape T is drawn out from the case 14. The opening 16 is arranged such that during non-use of the recording tape cartridge 12 (magnetic tape T) it is closed by a door 18, while it is open during use of the recording tape cartridge 12 in the drive device. Further, a leader pin 20 is attached to the fore end of the magnetic tape T. The leader pin 20 is formed in a small column-like shape such that flange portions 20A, which are provided at the longitudinal opposite ends of the leader pin which extend upward and downward beyond the widthwise edge portions of the magnetic tape T, are engaged by drawing-out members of the drive device so as to cause the magnetic tape T to be drawn out from the case 14.

The case 14 is comprised of an upper case half 22 and a lower case half 24 which are jointed together. The upper case half 22 is comprised of a top plate 22A which is approximately rectangular as viewed in a plan view, and a substantially frame-like peripheral wall 22B which is provided along an outer edge of the top plate 22A. The lower case half 24 is comprised of a bottom plate 24A which substantially corresponds in shape to the top plate 22A, and a peripheral wall 24B provided along an outer edge of the bottom plate 24B. Further, the case 14 is structured in a substantially box-like configuration with the upper and lower case halves 22 and 24 jointed together by ultrasonic bonding or screwing in a state such that opening ends of the peripheral walls 22B and 24B are placed in abutment with each other.

The opening 16 is configured in a substantially rectangular form as viewed in a side view and is open to the right at the front end of a right side wall 14A of the case 14 which extends in the direction of the arrow A (a rightwardly facing wall of the case 14 which is formed by the peripheral walls 22B and 24B). The top and bottom plates 22A and 24A are provided with pin receiving recesses 26 which are adapted to receive flange portions 20A of the upstanding leader pin 20, respectively. Each of the pin receiving recesses 26 is also rightwardly open in the vicinity of the front end of the opening 16, thus allowing for ingress and egress of the leader pin 20 relative to the case 14 via the opening 16. Further, a leaf spring 28 is mounted in the vicinity of the front end of the case 14 and which is provided with a pair of, top and bottom, arms 28A. The leaf spring 28 is configured such that the respective arms 28A thereof are engaged at their fore ends with the flange portions 20A of the leader pin 20, thereby retaining the leader pin 20 with respect to the case 14. This retaining state can be released by pulling the leader pin 20 to the right with a force in excess of a predetermined magnitude.

The door 18 for opening and closing the opening 16 is configured in an approximately rectangular plate-like shape so as to be capable of enclosing the opening 16 on its own. The top and bottom edges of the door 18 are slidably fitted in guide grooves 30 which are provided on the top and bottom plates 22A and 24A along the open face of the opening 16 and the right side wall 14A, respectively. Thus, in this structure, the door 18 is permitted to selectively assume a closed position where it closes the opening 16 and an open position where it opens opening 16, by being slidingly moved forwards and backwards along the guide grooves 30. Further, the door 18 is forwardly biased by a coil spring 32 which is a biasing member provided between the door 18 and the case 14, so that the door 18 is normally located in the closed position due to the biasing force of the coil spring 32. At the front end of the door 18 is provided an operation portion 18A extending to the right, and by pushing the operation portion 18A backwards against the biasing force of the coil spring 32, the door 18 can be moved to the opening position.

Further, the bottom plate 24A of the case 14 is formed in the center portion thereof with a gear opening 34 through which a reel gear 50, described later, of the reel 10 is exposed. It is configured so that the reel 10 is rotationally driven in the case 14, and without contact therewith, in response to rotation of a drive gear of the drive device which is meshed with the reel gear. In addition, the case 14 includes guidance/restriction walls 36 which are upstandingly provided in a manner to extend in parts from the top and bottom plates 22A and 24A with the upper and lower ends thereof disposed in abutment with each other. The guidance/restriction walls 36 serve to prevent the reel 10 from rattling, while at the same time preventing dust or the like from entering the area in which the reel 10 is disposed, because of being contiguous with the peripheral walls 22B and 24B.

Further, in the rear right corner in the case 14 is provided a memory board M in which various information concerning each recording tape cartridge is stored on a per-cartridge basis.

The memory board M is inclined about 45° with respect the bottom plate 24A and supported by means of a pair of support ribs 38 whose upper edges serving as the supporting surfaces are tilted forward at a predetermined angle (45° in this embodiment).

In FIG. 1, the reel 10 is shown in a partly cut-away side view. As shown therein, the reel 10 includes a hub 40 which constitutes the center axis portion thereof. The hub 40 is configured in an approximately bottomed cylindrical shape having an upwardly opened open end 40A and includes a cylindrical portion 42 on the circumferential surface of which a magnetic tape T is wound, and a bottom portion 44 closing the lower portion of the cylindrical portion 42. In this embodiment, a lower flange 46 is provided coaxially and integrally with the hub 40 in the vicinity of the end portion on the bottom portion 44 side (one end in the axial direction) in a manner to extend radially outwardly from the hub 40.

Meanwhile, an upper flange 48, which has an inner diameter substantially equal to that of the cylindrical portion 42 and an outer diameter substantially equal to that of the lower flange 46, is coaxially joined to the upper end portion (open end 40A) of the hub 40 by means of ultrasonic welding or the like. More specifically, the upper flange 48 are ultrasonically welded to the upper end surface of the cylindrical portion 42 in a state that a short cylindrical portion 48A provided at the center axis portion of the upper flange 48 is inserted in the open end 40A of the hub 40. In this manner, the heel 10 is structured such that the magnetic tape T is wound on the outer circumference of the cylindrical portion 42 (hub 40) between the opposing surfaces of the lower and upper flanges 46 and 48. The lower and upper flanges 46 and 48 serve to restrict displacement in the widthwise direction (in the axial direction of the hub 40) of the magnetic tape T wound on the hub 40.

A reel gear 50, which is annularly formed, is provided on the outer surface (lower surface) of the bottom portion 44 of the hub 40 in the vicinity of the outer circumference of the hub 40. The reel gear 50 is exposed from the gear opening (FIG. 8) of the case 14 and can be placed into and out of engagement with a drive gear provided on the fore end of the rotary shaft of the drive device, by being moved relative to the rotary shaft of the drive device along the axial direction thereof. Further, an unillustrated reel plate made from a magnetic material is integrally provided using an insert molding technique on the lower surface of the bottom portion 44 radially inside of the reel gear 50. The reel plate is attracted and held in a non-contact manner by a magnet provided on the fore end of the rotary shaft of the drive device.

Further, it is configured so that an unillustrated lock mechanism is provided inside the hub 40 for preventing the reel 10 from being rotated during non-use of the magnetic tape T. The lock mechanism includes a lock member which is prevented from rotation relative to the case 14 and supports the lock member such that the lock member can be placed in and out of contact with the bottom portion 44 of the reel 10. In this configuration, because of being placed in or out of contact with the bottom portion 44, the lock member is permitted to assume either a rotation lock position, where the lock member is engaged with an engagement portion (not shown) of the bottom portion 44 thereby preventing the reel 10 from being rotated relative to the case 14, or a release position, where the engagement of the lock member with the engagement portion is released thereby allowing for rotation of the reel 10. To this end, the engagement portion which is engaged with the lock member is provided on the bottom portion 44, and an operation hole (not shown) is formed through which a lock release member of the drive device operates the lock member from outside. The operation hole may be provided in the center axis portion of the bottom portion 44. Alternatively, it may be provided in a portion spaced apart from the center axis portion of the portion in which the reel gear 50 is formed.

As will be appreciated from the above description, the bottom portion 44 of the hub 40 serves to achieve the function that the reel gear 50 is formed therein so as to allow for transmission of a rotational force from the drive device; the function that the bottom portion 44 closes the gear opening 34 of the case 14 during non-use of the case 14; and the function that the bottom portion 44 is engaged with the lock member so as to prevent the reel 10 from being rotated relative to the case 14 Meanwhile, the upper end of the center axis portion of the reel 10 is required to be open in order to provide the above-described lock member between the case 14 and the bottom portion 44. In this embodiment, the hub 40 has the open end 40A.

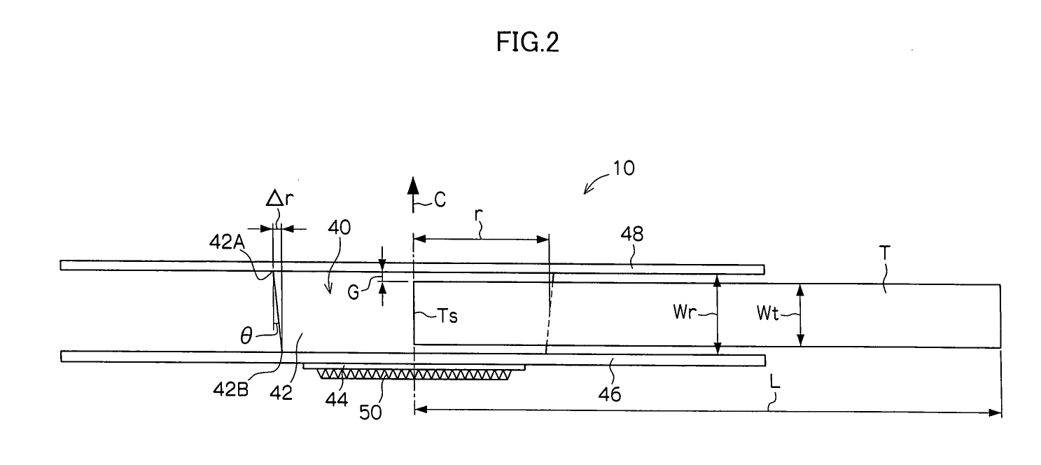

The reel 10 is configured such that the magnetic tape T is wound on the outer circumference of the hub 40. More specifically, as shown in FIG. 2, the reel 10 is configured such that a longitudinal end portion of the magnetic tape T is initially adhered to the outer circumference of the hub due to adhesive force of a liquid such as water, alcohol or the like, and then the magnetic tape T is wound on the outer circumference of the cylindrical portion 42 (hub 40). The magnetic tape T adhered to the cylindrical portion 42 due to the adhesive force of the above-described liquid is wound onto the outer circumference of the cylindrical portion 42 under a weak amount of tension that the adhesive force of the liquid can withstand. Further, when a predetermined length L of the magnetic tape T is wound on the cylindrical portion 42, a state is established that can withstand the required tension by virtue of frictional retention force and a winding pressure imparted by the outermost layer of the wound magnetic tape T, even if the adhesive force of the liquid is lost due to evaporation of the liquid. After the predetermined length L of the magnetic tape T has been wound on the cylindrical portion 42, the magnetic tape T is strongly wound (wrapped in a superimposed manner) under a certain tension.

In this embodiment wherein the width Wt of the magnetic tape T is 12.65 mm and the outer radius r (the radius of the axially central portion) of the cylindrical portion 42 is 22.00 mm, a length of the magnetic tape T that is wound three turns (three wraps) onto the cylindrical portion 42 is represented by L. That is, the number of turns n of the magnetic tape T wound on the cylindrical portion 42, L can be represented by

L=2πrn

where the thickness of the magnetic tape T is neglected since the number of turns n (=3) is small. In this regard, it is only required that this length L be a design length which is in excess of the actual length required for establishing a state that the magnetic tape T wound on the cylindrical portion 42 can withstand a given tension, and a safety factor or the like may be taken into account.

The reel 10 described above, except for the upper flange 48, is integrally molded from a resin material (the metallic reel plate is insert-molded as described above). That is, the cylindrical portion 42 and bottom portion 44 of the hub are integrally molded. Further, the hub 40 is formed in a tapered shape in which the open end 40A, which exhibits less shrinkage after mold removal, is relatively wide and the cylindrical portion 42 has a larger diameter on the upper end side than on the lower end side, for the reason that the lower end is closed by the bottom portion while the upper end forms the open end 40A. Thus, the cylindrical portion 42 may also be referred to as a conical portion.

Let it be assumed that a taper angle that the outer circumference (tapered surface) of the cylindrical portion 42 (hub 40), which is formed in a tapered shape as described, with respect to the axial direction is [symbol] . Description will now be made of a way to determine an upper limit for the taper angle θ, that is a method of designing the reel 10.

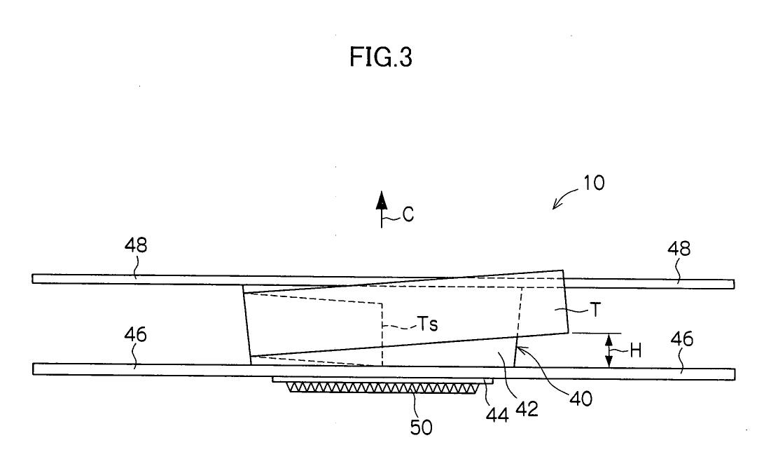

As shown in FIG. 3, as the magnetic tape T is wound onto the outer circumference of the tapered cylindrical portion 42, the magnetic tape T is spirally wound while being displaced upward (toward the lager-diameter side) with respect to the cylindrical portion 42 by following the tapered surface of the cylindrical portion 42. FIG. 3 illustrates an amount of displacement H of the magnetic tape T in the upward direction. (For the sake of better understanding, FIG. 3 illustrates a state in which the magnetic tape T has begun to be wound with the lower edge thereof disposed in registration with a boundary portion 42B (FIG. 2) between the lower flange 46 and the cylindrical portion 42.) As this amount of displacement H increases, the upper edge of the magnetic tape T will be brought into contact with the upper flange 48.

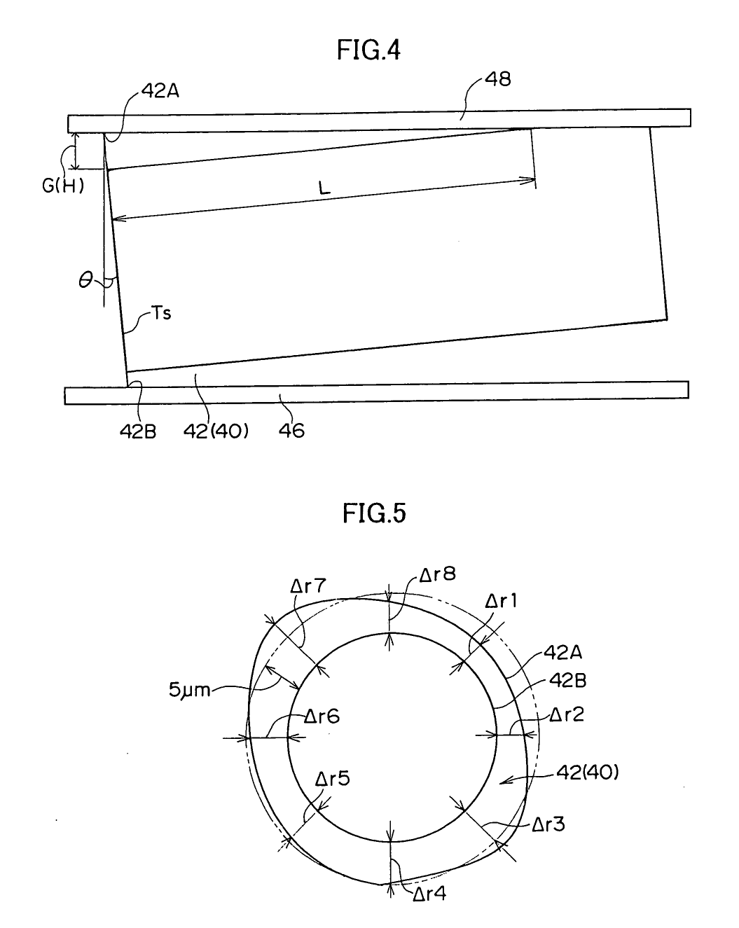

Thus, assuming that a spacing along the axial direction between the upper edge (widthwise upper end) at a winding start end Ts of the magnetic tape T and a boundary portion 42A (FIG. 2) between the cylindrical portion 42 and the upper flange 48 is G (see FIGS. 2 and 4), the magnetic tape T will not contact the upper flange 48 whilst the amount of displacement H when the length L of the magnetic tape T is wound on the cylindrical portion 42 is smaller than the spacing G. Although not shown, a structure is adopted in which the upper flange 48 has its lower surface formed as a tapered surface such that the distance between the opposing surfaces of the lower and upper flanges 46 and 48 is wider outside than inside in the radial direction, thereby preventing interference with the magnetic tape T from radially outside portions.

As diagrammatically shown in FIG. 4 which shows the cylindrical portion 42 expanded out (opened up) into a plane, an angle formed between the longitudinal direction of the magnetic tape T in a spiral form and a direction orthogonal to the axis of the cylindrical portion 42 (a plane containing the boundary portion 42A), that is a spiral angle of the magnetic tape T, conforms to the taper angle θ. Further, since the spacing G that determines the upper limit for the amount of displacement H and the winding length L are known, an upper limit for the taper angle θ can be determined from equation (1) given below.

θ<sin⁻¹(G/L) (1)

Further, in this embodiment, as shown in FIG. 2, a width along the axial direction of the hub between the boundary portion 42A between the cylindrical portion 42 and the upper flange 48 and the boundary portion 42B between the cylindrical portion 42 and the lower flange 46 is Wr, and the spacing G can be determined from equation (2):
G=(Wr−Wt)/2 (2)

Further, since L=2πrn as described above, by substituting this equation and equation (2) in equation (1), the taper angle θ can be determined from equation (3) given below.
θ=sin⁻¹((Wr−Wt)/4πrn (3)

In this embodiment, the width Wt of the magnetic tape T is 12.65 mm, the outer radius r of the cylindrical portion 42 is 22.00 mm, and n is 3. Further, the opposing distance (width) Wr along the axial direction of the hub between the lower and upper flanges 46 and 48 at the internal radius is set to be equal to 12.96 mm. By substituting these numerical values in the equation (3), the upper limit for the taper angle θ was obtained such that θ<0.021°. Still further, in this embodiment, the difference Ar in outer radius between the upper end and the lower end of the cylindrical portion 42 becomes less than about 5 μm since Δr=Wr×tan θ.

On the other hand, in the reel 10 in an actual product, the taper angle of the cylindrical portion 42 is set to be such that θ0<0.021°, and more specifically, the difference Δr in outer radius between the upper and the lower portion of the cylindrical portion 42 is set to be such that Δr<5 μm. As can be surmised from this numerical value, the taper angle θ and the difference Δr between the upper and the lower portion of the cylindrical portion 42 are shown exaggeratedly in the respective figures.

Here, as shown diagrammatically in FIG. 5, the cylindrical portion 42 in an actual product is not precisely a perfect circle as viewed in a plan view, and thus variations exist in the difference Δr in outer radius at various circumferential points. In FIG. 5, an inner circle represents the boundary portion 42B between the cylindrical portion 42 and the lower flange 46, and an outer deformed circle indicates the boundary portion 42A between the cylindrical portion 42 and the upper flange 48. A dotted line circle has a radius larger by 5 μm than that of the boundary portion 42B. For example, it is noted that a minimum value Δr1 for the difference Ar in outer radius shown in FIG. 5 is sufficiently smaller than 5 μm while a maximum value Δr7 is greater than 5 μm.

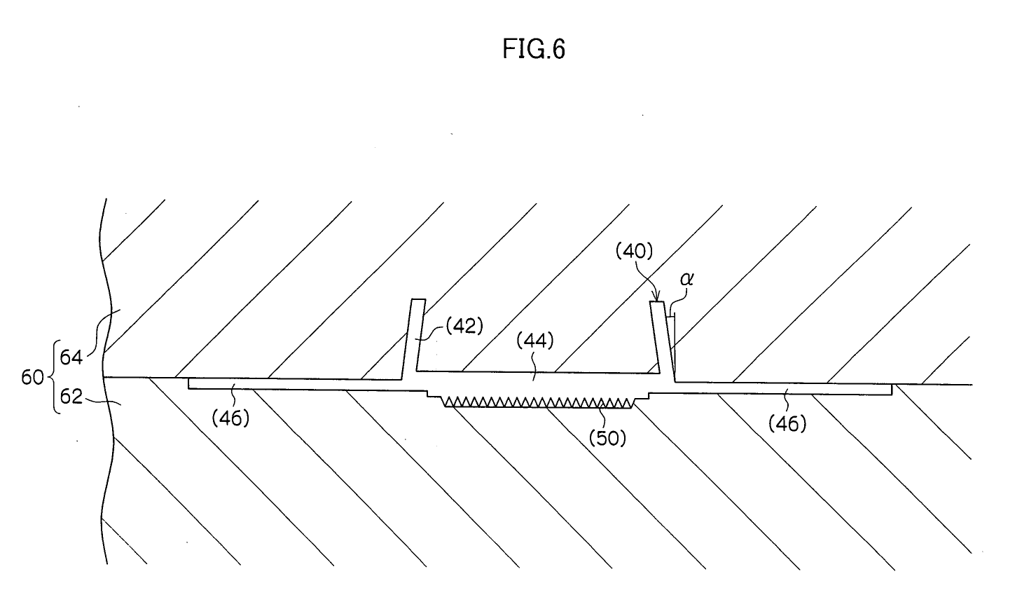

In this embodiment, the cylindrical portion 42 of the hub 40 is configured such that an average value Δra of the difference Δr in outer radius becomes less than 5 μm. The average value Δra of the difference Δr in outer radius can be sought from an equation Δra=ΣΔri/N wherein N represents the number of measurement points. In order to obtain the hub 40 having the cylindrical portion 42 in which the difference Δr in outer radius is less than 5 μm, a mold 60 such as shown in FIG. 6 is employed. Meanwhile, bracketed reference numerals indicate spaces defined by the mold 60 of FIG. 6 which correspond to the parts of the reel 10 which are formed by the mold 60. Further, it is to be noted that when description is made using the terms upward and downward directions, such upward and downward directions correspond to the upward and downward directions of the reel 10.

The mold 60 is comprised of a fixed mold 62 and a movable mold 64. The movable mold 64 is adapted to form the inner and outer circumferences of the cylindrical portion 42 of the hub 40 and the upper surface of the lower flange 46. In the movable mold 64, the space for forming the cylindrical portion 42 is defined in an inverse taper shape, which has a smaller diameter at the upper end side than at the lower end side, with respect to the cylindrical portion 42 as molded. In other words, the mold 60 defines a negative draft angle. This negative draft angle α is set such that after mold removal, the cylindrical portion 42 is ultimately formed in the aforementioned tapered shape having a greater diameter at an upper end side than at a lower end side (the value of Δra becomes positive). More specifically, an article including the hub 40, which has been removed from the mold 60, is subjected to greater shrinkage at a lower end side than at an upper end side due to thermal shrinkage accompanied by cooling, and hence the negative draft angle α is determined such that the size of the diameters at the upper and lower ends of the cylindrical portion are reversed due to the difference in shrinkage.

Description will next be made of the operation of this embodiment.

When the recording tape cartridge 12 is loaded into the drive device in order to record information on the magnetic tape T or reproduce information recorded on the magnetic tape T, the reel 10 structured as described above is released from rotation lock with respect to the case 14, and rotated in response to rotation of the rotary shaft whose drive gear is engaged with the reel gear 50. At this point, the leader pin 20, which has already been taken out from the opening 16, is retained by a take-up reel of the drive device, and the magnetic tape T is sequentially drawn out from the case 14 in response to the take-up reel being rotated in synchronism with the reel 10. Thereupon, a recording/reproducing head provided along a predetermined tape path records information on the magnetic tape T or reads information recorded on the magnetic tape T. After the magnetic tape T has been used, the reel 10 winds in the magnetic tape T and returns to the initial state.

When the magnetic tape T is wound onto the reel 10, the cylindrical portion 42 of the hub 40 is wetted with a liquid such as water, alcohol or the like, and the end portion of the magnetic tape T is adhered to the cylindrical portion due to the adhesive force of the liquid. Before the adhesive force is lost due to evaporation of the liquid, the magnetic tape T is wound a predetermined number of turns (three turns in this embodiment) under relatively low tension onto the outer circumference of the cylindrical portion 42. In doing so a state in which the magnetic tape T can withstand being wound under a given tension is arrived at. Subsequently, the tension of the magnetic tape T is increased up to the predetermined magnitude, and at the same time the winding speed (rotational speed of the reel 10) is increased; in such a state, the magnetic tape T is wound on at a predetermined length.

In the reel 10, the taper angle θ of the cylindrical portion 42 is set such that θ<sin⁻¹(G/L). In other words, the average value Δra of the difference in outer radius between the upper and lower ends 42A and 42B of the cylindrical portion 42 is less than 5 μm. Consequently, it does not occur that the amount of displacement H in the widthwise direction of the magnetic tape T, which tends to be caused when the magnetic tape T is wound by the predetermined length L onto the cylindrical portion 42, becomes equal to the initial spacing G between the winding start end of the magnetic tape T and the upper flange 48 (boundary portion 42A). Thus, the magnetic tape T is prevented from contacting the upper flange even when the magnetic tape T is wound onto the cylindrical portion 42 under a relatively low tension that produces only a limited orientation-correcting effect.

When the magnetic tape T is wound by the length L (three turns) onto the cylindrical portion 42, there occurs a state in which the magnetic tape T can withstand a given tension, as described above, and thus, thereafter, the magnetic tape T is wound on at the above-mentioned predetermined length onto the cylindrical portion 42, without contacting the upper or lower flanges, while being corrected in terms of orientation under a given tension (while being controlled such that the longitudinal direction of the magnetic tape T conforms to a direction orthogonal to the axis of the hub 40).

As will be appreciated from the above description, according to the reel 10 of this embodiment and the method for designing the reel 10, the magnetic tape T can be wound onto the cylindrical portion 42 without interfering with the upper and lower flanges 46 and 48.

Although, in the above-described embodiment, description has been made of an example in which the cylindrical portion 42 of the hub 40 is formed in a tapered shape such that the outer diameter is greater at an upper end side than at a lower end side, it is to be understood that the present invention is by no means limited thereto, and that the cylindrical portion 42 may be formed in a tapered shape such that the outer diameter is greater at a lower end side than at an upper end side, for example.

Further, although in the above-described embodiment, description has been made of an example in which the lower flange 46 is formed integrally with the hub 40, it is to be understood that the present invention is by no means limited thereto, and that the upper flange 48 may be integral with the hub 40, for example.

Furthermore, although in the above-described embodiment, the cylindrical portion 42 is structured such that it has a tapered shape, the present invention is by no means limited thereto, and it is needless to say that the cylindrical portion 42 may be configured such that the resulting taper angle θ is assessed to be 0° (Δra is nearly equal to 0 μm).

Still further, although in the foregoing embodiment, description has been made of an example in which the magnetic tape T begins to be wound on a vertical center portion of the cylindrical portion 42 (the upper and lower spacings G are equal to each other), the present invention is by no means limited thereto, and it is to be understood that it is also possible that the magnetic tape T may begin to be wound in a manner that the lower edge of the winding start end Ts of the magnetic tape T is offset toward the boundary portion 42B (lower flange 46), for example, as shown in FIG. 3.

Furthermore, although in the foregoing embodiment, description has been made of an example in which the reel 10 is applied to the recording tape cartridge 12 which is structured such that a single reel is accommodated in the case 14, it is to be understood that the present invention is by no means limited thereto, and that the reel 10 is equally applicable to a recording tape cartridge of a double-reel type in which two reels are accommodated in a case.

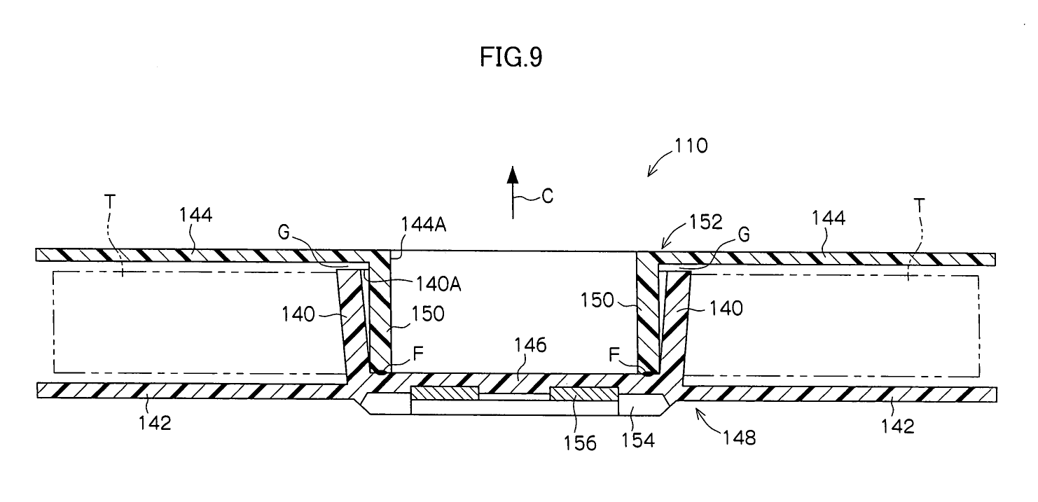

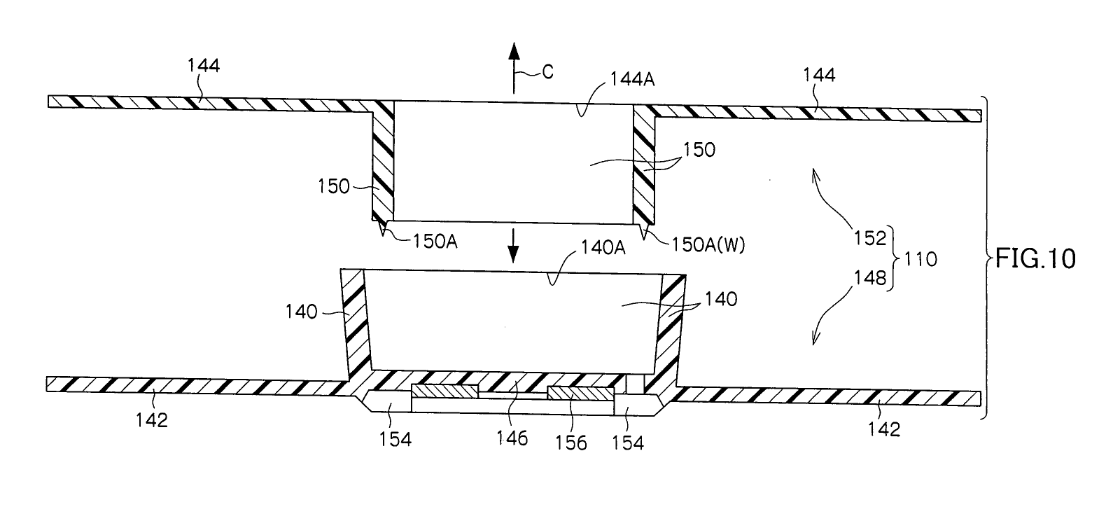

With reference to FIGS. 9-10, description will next be made of a reel 110 according to a second embodiment of the present invention.

In FIGS. 9 and 10, the reel 110 is shown in a sectional view and an exploded sectional view, respectively. As shown in these figures, the reel 110 includes a hub 140 which constitutes a center axis portion, a lower flange 142 as a first flange located at a lower end side of the hub 140, and an upper flange 144 as a second flange located at an upper end side of the hub 140 in facing relationship to the lower flange 142.

The hub 140 is formed in an approximately tapered cylindrical shape in which the outer diameter is greater at an upper end side than at a lower end side, and in this embodiment, both the inner and outer surfaces of the hub 140 are a tapered surface whose diameter continuously increases toward the upper side. The taper angle of the outer circumference of the hub 140 is set such that the difference between the outer radii at the upper and lower ends of the hub 140 falls within a range from 20 μm to 50 μm in the case of a structure of a magnetic tape T having a width of 12.7 mm.

The flange 142 is configured in a manner to extend coaxially and radially outward from a lower end portion of the hub 140. Further, a bottom plate portion 146 is provided in a manner to extend radially inward from the lower portion of the hub 140, and which closes the end portion of the hub 140. The upper end of the hub 140 is formed as an open end 140A. The hub 140, the lower flange 142, and the bottom plate portion 146 are integrally formed from a plastic material, and this integral member will be referred to as a first reel member 148.

The upper flange 144 is formed in an annular shape whose outer diameter is equal to the outer diameter of the lower flange 142 and in which an opening portion 144A is formed in the center axis portion thereof. A fixed tubular potion 150 as a fixed portion is provided in a downwardly extending manner at the edge portion of the opening portion 144A of the upper flange 144. The fixed tubular portion 150 is formed in an approximately cylindrical shape such that the outer diameter thereof is slightly smaller than the inner diameter (minimum inner diameter) at the lower end of the hub 140. The upper flange 144 and the fixed tubular portion 150 are integrally formed by a plastic molding process, and this integral member will be referred to as a second reel member 152. As shown in FIG. 10, welding projections (energy directors) 150A for the purpose of ultrasonic welding are provided on the lower end surface of the fixed tubular portion 150 of the second reel member 152.

In the reel 110, the second reel member 152 is secured at a welding portion (securing portion) F to the first reel member 148, as shown in FIG. 9, by performing ultrasonic welding with the fixed tubular portion 150 of the second reel member 152 inserted in the hub 140 of the first reel member 148 and with the welding projections 150A placed in engagement with the upper surface of the bottom plate portion 146. In this manner, the upper flange 144 is fixed with respect to the hub 140 without being directly secured thereto. In this state, a slight gap G is formed between the upper end of the hub 140 and the lower surface of the upper flange 144.

Further, a reel gear 154 is provided on the outer surface (lower surface) of the bottom plate portion 146 of the first reel member 148 and in vicinity of the outer circumference of the first reel member 148. The reel gear 154 is exposed through the gear opening 34 of the case 14 (see FIGS. 7 and 8), and moved relative to a rotary shaft of a drive device along the axial direction of the rotary shaft so that the reel gear 154 can be placed in and out of engagement with a drive gear provided on the fore end of the rotary shaft. Further, a reel plate 156 made from a magnetic material is integrally provided in the lower surface of the bottom plate portion 146, radially inside of the reel gear 154, by an insert molding process. The reel plate 156 is adapted to be attracted and supported in a non-contact state by a magnet provided on the fore end of the rotary shaft.

Further, an unillustrated lock mechanism is provided inside the fixed tubular portion 150 (hub 140), which acts to prevent the reel 110 from being rotated during non-use of the magnetic tape T. The lock mechanism includes a lock member which is prevented from rotating relative to the case 14 and supports the lock member in a manner that the lock member can be placed in and out of contact with the bottom plate portion 146 of the reel 110. The lock member is designed so as to selectively assume a rotation lock position where the lock member is engaged with an engagement portion (not shown) of the bottom plate portion 146 thereby preventing the reel 110 from rotating with respect to the case 14, or a release position where the lock member is disengaged from the engagement portion thereby allowing for rotation of the reel 110, in response to being placed in or out of contact with the bottom plate portion 146. To this end, the bottom plate portion 146 is provided with the engagement portion which is engageable by the lock member and also with an operation hole (not shown) through which the lock member can be operated from outside by a lock release member of the drive device. The operation hole may be provided either in the center axis portion of the bottom plate portion 146 or in a portion spaced apart from the center axis portion, such as a portion in which the reel gear 154 is formed.

As will be appreciated from the above description, the bottom plate portion 146 of the hub 140 is adapted to perform the function that permits the reel gear 154 to be formed therein, such that a rotational force is transmitted thereto from the drive device; the function of closing the gear opening 34 of the case 14 during non-use of the recording tape cartridge; and the function of permitting engagement of the lock member, thereby preventing the reel 110 from rotating relative to the case 14. Meanwhile, it is required that the upper end of the center axis portion of the reel 110 be open so as to enable the above-described lock member to be provided between the case 14 and the bottom plate portion 146. For this reason, in this embodiment, a space whose opening end comprises the open portion 144A of the second reel member 152 (a space in the fixed tubular portion 150) is defined in the hub 140. In this manner, the hub 140, which is closed at the lower end with the bottom plate portion 146 adapted to perform the above-mentioned various functions, is made, by virtue of the reinforcement effect of the bottom plate portion 146, to possess a higher strength (higher rigidity) with respect to a winding pressure of the magnetic tape T at a lower end side than at an upper end side where the open end 140A is provided. Meanwhile, at the hub 140, in which the upper flange is not secured to the upper end thereof, the lower end thereof and the lower flange 142 are also structured so as to have a higher strength than at the hub upper end.

Next, the operation of the second embodiment will be described below.

When the recording tape cartridge 12 (see FIGS. 7 and 8) is loaded into the drive device in order to record information on the magnetic tape T or reproduce information recorded on the magnetic tape T, the reel 110 structured as described above is released from rotation lock relative to the case 14 and rotated in the case 14 in response to rotation of the rotary shaft whose drive gear is engaged with the reel gear 154. At this point, the leader pin 20, which has already been taken out from the opening 16 (see FIGS. 7 and 8), is held by a take-up reel of the drive device, and the magnetic tape T is sequentially drawn out from the case 14 in response to the take-up reel being rotated in synchronism with the reel 10. Thereupon, a recording/reproducing head provided along a predetermined tape path records information on the magnetic tape T or reads information recorded on the magnetic tape T. After the magnetic tape T has been used, the reel 110 winds up the magnetic tape T and returns to the initial state.

When the magnetic tape T is wound onto the reel 110, an end portion of the magnetic tape T is adhered to the outer circumference of the hub 140 with a liquid such as water, alcohol or the like. Before the adhesive force of the liquid is lost, due to evaporation of the liquid, the magnetic tape T is wound a predetermined number of turns (three turns in this embodiment) under a relatively low tension onto the outer circumference of the hub 140. This results in a state in which the magnetic tape T can withstand being wound under a given tension. Subsequently, the magnetic tape T is wound on at the prescribed length under a given tension. At this point, there is a tendency that the hub 140 is deformed radially inward (hereinafter, referred to as deformed inward) more greatly at an upper end side than at a lower end side due to a winding pressure of the magnetic tape T since the strength of the hub 140 with respect to the winding pressure of the magnetic tape T is lower at an upper end side where the open end 140A exists than at a lower end side where the hub is closed by the bottom plate portion 146.

In the reel 110, since the upper flange 144 is not securely fixed to the hub 140, there is no likelihood that the upper flange 144 will be deformed in response to deformation of the hub. Further, since the hub 140 is configured in a tapered shape such that the outer diameter is larger at an upper end side than at a lower end side, the lower end portion of the hub 140 is subjected to little or no winding pressure of the magnetic tape T. For this reason, despite the hub 140 being deformed inward at an upper end side in the axial direction (at the low strength side) by winding the magnetic tape T thereon, inward deformation (angle) of the lower end portion (the lower flange side end portion) of the hub is suppressed such that the lower flange 142 is prevented or restrained from being displaced or deformed so as to approach the magnetic tape T. As can be seen for the above description, in the reel 110, the lower and upper flanges 142 and 144 are prevented or restrained from contacting the magnetic tape T, even if the hub 140 is deformed inward at the upper end side in the axial direction (lower strength side) because of the magnetic tape T being wound onto the hub 140.

Further, since the reel 110 is made up of two members, i.e., the first and second reel members 148 and 152, which are joined together, the function to suppress displacement or deformation due to inward deformation of the hub 140 can be performed without increasing the number of parts.

As described above, the reel 110 according to the second embodiment of the present invention is capable of preventing the lower and upper flanges 142 and 144 from contacting the magnetic tape T without increasing the number of parts. In particular, since the hub 140 has a tapered structure, displacement or deformation of the lower flange 142 toward the magnetic tape T can be suppressed due to the tapered configuration of the hub without the necessity of constructing the hub 140 so as to have an increased rigidity, for example, by incorporating a carbon fiber or the like into a plastics material from which the hub 140 is formed.

Further, since the second reel member 152 is secured to the bottom plate 146 of the first reel member 148 at the lower end of the fixed tubular portion 150 configured in a cylindrical shape, the mounting rigidity of the upper flange 144 with respect to the first reel member 148 (hub 140) (the rigidity of the fixed tubular portion 150 per se which is structured so as to have a closed section) is high, and the dimensional accuracy (mounting accuracy) after the first and second reel members 148 and 152 are joined together is excellent. In addition, the mold structure for the second reel member 152, in which the upper flange 144 and the fixed tubular portion 150, are integrally formed is not complicated when compared with that for an upper flange which is secured to a hub.

Furthermore, the hub 140 having the above-mentioned tapered structure is more greatly deflected radially inward at the upper end side where the winding pressure of the magnetic tape T is higher and the outer circumferential surface thereof becomes an approximately cylindrical surface in a state in which the magnetic tape T is wound thereon. Thus, a likelihood is avoided that the circumferential length of the hub is different on the magnetic tape T at various points along the widthwise direction of the magnetic tape T, and consequently the extension rate of the magnetic tape T becomes stable at various points along the widthwise direction of the magnetic tape T (one-side extension is prevented).

Next, other embodiments of the present invention will be described. Components and parts which are basically the same as those of the foregoing embodiments are indicated by the same references, and further description thereof will be omitted.

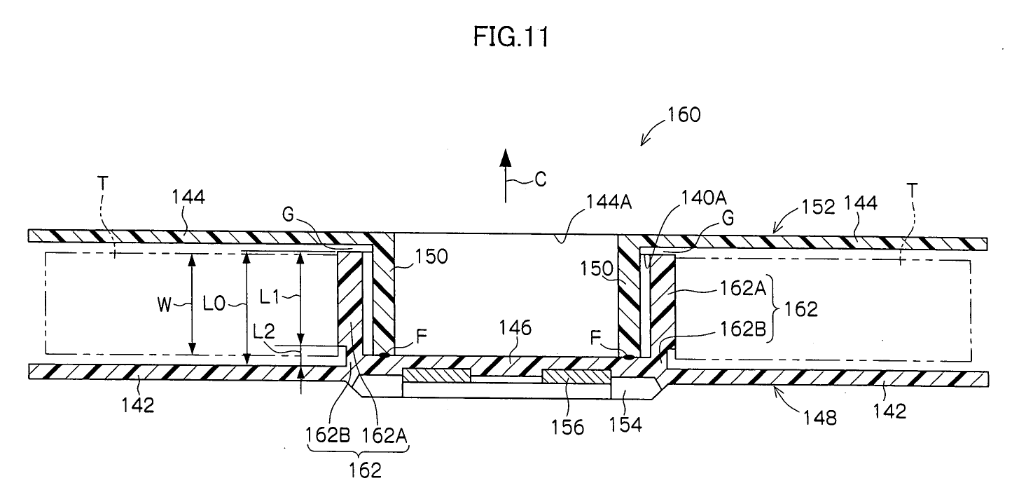

FIG. 11 is a sectional view showing a reel 160 according to the present invention. As shown in this figure, the reel 160 is different from the reel 110 according to the second embodiment in that it includes a hub 162 instead of the hub 140. The hub 162 is structured such that it includes a larger-diameter 162A and a smaller-diameter 162B, which are different in outer diameter from each other, between a lower and an upper flange 142 and 144. The smaller-diameter portion 162B is provided at a lower end side of the hub 162 in a manner to form an annular recess portion between the larger-diameter portion 162A and the lower flange 142. The portion of the outer circumference of the hub 162 between the lower and upper flanges 142 and 144, or more precisely the region between the upper surface of the lower flange 142 and the upper end of the hub 162 constitutes a region on which the magnetic tape T is wound, and the axial length of that region is set to be a length L0 which is slightly greater than the width W of the magnetic tape T.

Accordingly, the smaller-diameter portion 162B is formed in part of the magnetic tape winding region of the hub 162 (the axially lower end portion), and the axial length L2 of the smaller-diameter portion 162B is such that L2=L0−L1 where L1 is the axial length of the larger-diameter portion 162A. In this embodiment, the ratio of the axial length of the larger-diameter portion 162A to that of the smaller-diameter portion 162B, or L1:L2 is set so as to be within a range from 10:1 to 5:1. In other words, the length L2 of the smaller-diameter portion 162B is set so as to be within a range from 1/10 to ⅕ with respect to the length L1 of the larger-diameter portion 162A (from 1/11 to ⅙ with respect to the axial length L0 of the outer circumference of the hub 62). Meanwhile, instead of the length L0, the width W of the magnetic tape T may be used as a reference for setting the length of the smaller-diameter portion 162B.

The reel 160 described above is structured such that when the magnetic tape T is wound onto the hub 162, a winding pressure (surface pressure) of the magnetic tape T is supported primarily by the larger-diameter portion 162A, while little or no winding pressure of the magnetic tape T acts on the smaller-diameter portion 162B. The reel 160 is also structured such that the second reel member 152 is joined to the first reel member 148 including the hub 162, instead of the hub 140 as in the above-described second embodiment. The other structures of the reel 160 are identical to the corresponding structures of the reel 110.

Consequently, the reel 160 according to the third embodiment can produce operational effects similar to those of the reel 110 according to the above-described second embodiment. More specifically, since the upper flange 144 is not secured to the hub 162 in the reel 160, there is no tendency for the upper flange 144 to be deformed in compliance with the hub 162. Further, since the smaller-diameter portion 162B provided on the lower end portion of the hub 162 is subjected to little or no winding pressure of the magnetic tape T, the larger-diameter portion 162A, which is located above the smaller-diameter portion 162B, is primarily deformed inward. That is, inward deformation (angle) of the smaller-diameter portion 162B which is the lower flange 142 side end portion of the hub 162 is suppressed, and concomitant inclination (displacement or deformation) of the lower flange 42 is also suppressed.

In this way, the reel 160 according to the third embodiment is capable of preventing contact between the magnetic tape T and the lower and upper flanges 142 and 144 without increasing the number of parts. Further, since the hub 162 is configured in the form of a stepped structure having the larger-diameter and smaller-diameter portions 162A and 162B, displacement or deformation toward the magnetic tape T of the lower flange 142 can be suppressed due to the stepped configuration of the hub 140 without the necessity of constructing the hub 140 so as to have an increased rigidity by incorporating a carbon fiber or the like into the plastic material from which the hub 140 is made.

Although in the third embodiment, the large-diameter portion 162A has an approximately cylindrical surface before the magnetic tape T is wound thereon, it is also possible that the larger-diameter portion 162A (the outer circumference thereof) may be configured in a tapered shape as is the case with the hub 140. In this configuration, as in the reel 110 having the hub 140, the outer circumference of the larger-diameter portion 162A becomes a cylindrical surface after the magnetic tape is wound thereon, thereby preventing one-side extension of the magnetic tape T. Further, although in the third embodiment, a preferred structure is illustrated in which the axial length L2 of the smaller-diameter portion 162B is 1/10-⅕ of the axial length L1 of the larger-diameter portion 162A, the present invention is not limited thereto, but it is also possible that the length L2 may be increased to a value equal to the length L1 (L2=L1=L0/2).

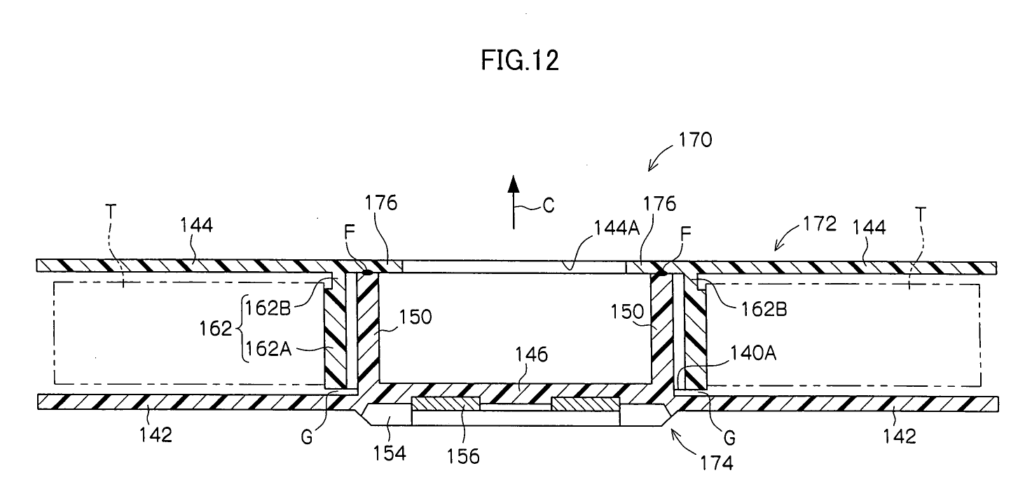

FIG. 12 is a sectional view showing a reel 170 according to a fourth embodiment of the present invention. As shown in this figure, the reel 170 is different from each of the above-described embodiments in that it is constituted by a first and a second reel member 172 and 174 which are joined together. In the first reel member 172, the hub 162 which is vertically inverted with respect to the third embodiment (the lower end is formed as an opening end) is formed coaxially and integrally with the upper flange 144, and the smaller-diameter portion 162B is interposed between the upper flange 144 and the larger-diameter portion 162A. An annular fixed seat position 176 is provided on the upper end of the hub 162 in a manner to extend radially inward and coaxially with respect to the hub 162. In the first reel member 172, due to a reinforcing effect of the fixed seat portion 176 and upper flange 144, the hub 162 is structured so as to have a higher strength with respect to a winding pressure of the magnetic tape T at an upper end side than at a lower end side.

The second reel member 174 is comprised of a lower flange 142, a bottom plate 146, and a vertically inverted (relative to the previous embodiment) fixed tubular portion 150, which are formed coaxially and integrally with each other. The second reel member 174 is structured in such a manner that the fixed tubular portion 150 is inserted in the hub 162 of the first reel member 172 and the second reel member 174 is secured to the first reel member 172 at a welding portion F (securing portion) as shown in FIG. 12, by performing ultrasonic welding with the upper end (unillustrated welding projection) disposed in abutment with the fixed seat portion. In this way, the upper flange 142 is fixed to the hub 162 without being secured directly to the hub 162. In such a state, a slight gap G is defined between the lower end of the hub 162 and the upper surface of the lower flange 142. In this fourth embodiment, the upper and lower flanges 144 and 142 correspond to the first and second flanges of this invention, respectively.

Like the reel 110 or 160 according to the second and third embodiments, the reel 170 according to the fourth embodiment described above also produces the effect of preventing the lower and upper flanges 142 and 144 from being displaced or deformed toward the magnetic tape T, even when the hub 162 is deformed inward due to winding pressure of the magnetic tape T. That is, in the reel 170, there is no tendency that the lower flange 142 is deformed in response to the hub 162 being deformed, since the lower flange 142 is not secured to the hub 162. In this case, since the smaller-diameter portion 162B provided on the upper end portion of the hub 162 receives little or no winding pressure from the magnetic tape T, the larger-diameter portion 162A located below the smaller-diameter portion 162B is predominantly deformed inward. More specifically, inward deformation (angle) of the smaller-diameter portion 162 located at the upper flange side end portion of the hub 162 is suppressed, and thus inclination (displacement or deformation) of the upper flange 144 is also suppressed.

Thus, with the reel 170 according to the fourth embodiment, it is possible to prevent the lower and upper flanges 142 and 144 from contacting the magnetic tape T without either increasing the number of parts or enhancing the rigidity of the hub 162. Further, in the reel 170, despite the fact that the fixed seat portion 176 is provided in a manner to extend from the upper end of the hub 162 of the first reel member 172, the difference in strength between the upper and the lower end of the hub 162 is small as compared with the second reel member 174 provided with the bottom plate portion 146. For this reason, the difference between the amounts of top and bottom deformations due to a winding pressure of the magnetic tape T is small, and thus the winding position of the magnetic tape T becomes stable.

In the structure according to the fourth embodiment, it is needless to say that instead of the hub 162, a hub 40 (vertically inverted with respect to the first embodiment) may be provided. On the other hand, in the structure according to the fourth embodiment, since the reel gear 154, to which a driving force provided by the drive device is transmitted, and the hub 162 on which the magnetic tape T is wound are separate members, it is desirable that a structure be adopted in which these separate members (the first and second reel members 172 and 174) can be centered with high accuracy.

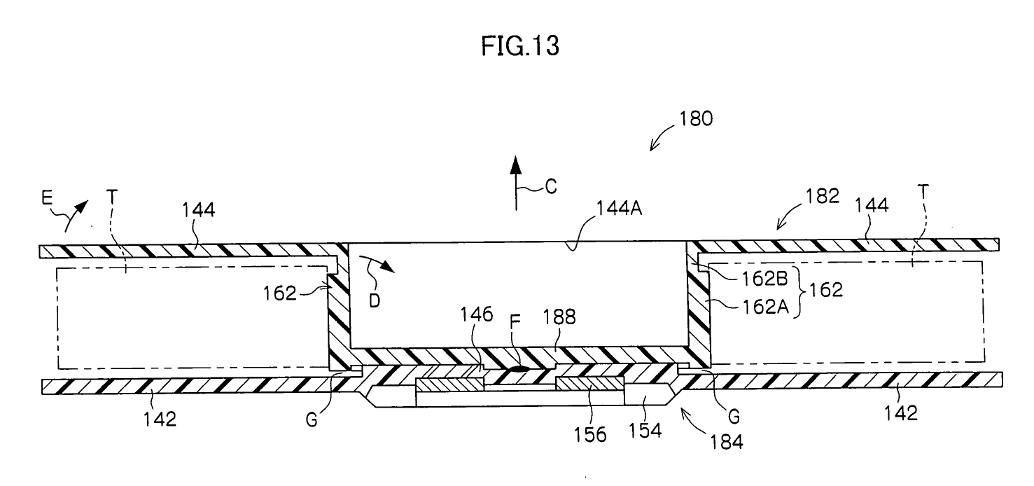

FIG. 13 is a sectional view showing a reel 180 according to a fifth embodiment of the present invention. As shown in this figure, the reel 180 is different from each of the above-described embodiments in the manner in which a first reel member 182 and a second reel member 184 are jointed together. In the first reel member 182, a hub 162 which is vertically inverted with respect to the fourth embodiment (where the lower end is an open end) is formed coaxially and integrally with an upper flange 144, and a smaller-diameter portion 162B is located between the upper flange 144 and a larger-diameter portion 162A. That is, the hub 162 of the first reel member 182 is constructed in a similar way to the hub 162 of the first reel member 172 according to the fourth embodiment. Further, the first reel member 182 is provided with a disc-like fixed seat portion 188 which closes the lower end portion of the hub 162. The first reel member 182 is structured such that the upper flange 144, the hub 162, and the fixed seat portion 188 are formed integrally with each other. Due to the existence of the fixed seat portion 188, the hub 162 has a higher strength with respect to a winding pressure of the magnetic tape T at a lower end side than at an upper end side.

The second reel member 184 is structured such that the lower flange 142 and the bottom plate portion 146 are formed integrally with each other. The second reel member 184 is securely fixed to the first reel member 182 because of the bottom plate 146 and the fixed seat portion 188 being welded together at a fixing position F by ultrasonic welding with the upper surface of the bottom plate portion 146 disposed in contact with the lower surface of the fixed seat portion 188 of the first reel member 182. That is, the lower flange 142 is fixed with respect to the hub 162 without being directly secured to the hub 162. In this state, a slight gap G is defined between the lower end of the hub 162 and the upper surface of the lower flange 142. In this fifth embodiment, the lower flange 142 corresponds to the second flange of this invention; the upper flange 144 to the first flange of this invention; and the bottom plate portion 146 to the fixed portion of this invention.

Like the reel 110, 160 or 170 according to the second, third and fourth embodiments, the reel 180 according to the fifth embodiment described above also produces the effect of preventing the lower and upper flanges 142 and 144 from being displaced or deformed toward the magnetic tape T, even when the hub 162 is deformed inward due to winding pressure of the magnetic tape T. That is, in the reel 180, there is no tendency that the lower flange 142 is deformed in compliance with the hub 162 being deformed, since the lower flange 142 is not secured to the hub 162. Further, the hub 162 is liable to be deformed inward at an upper end side due to the magnetic tape T being wound thereon since the hub 162 has a higher strength with respect to the magnetic tape T at a lower end side than at an upper end side. But because of the hub being structured such that little or no winding pressure acts on the smaller-diameter portion 162B, provided on the upper end portion having a lower strength, thus the winding pressure concentrates at the larger-diameter portion 162A (higher strength side), and deformation of the hub 162 due to winding pressure is suppressed. For this reason, the amount of displacement or deformation of the upper flange 44 in response to deformation of the hub 162 is also suppressed, and thus the upper flange 144 is prevented from contacting the magnetic tape T. Meanwhile, in this embodiment, it is also possible to prevent the upper flange 144 from contacting the magnetic tape T by configuring the hub 162 in a tapered shape in which an upper end side (lower strength side) is larger in diameter than a lower end side.

Thus, with the reel 180 according to the fifth embodiment, it is possible to prevent the lower and upper flanges 142 and 144 from contacting the magnetic tape T without either increasing the number of parts or enhancing the rigidity of the hub 162. In the fifth embodiment as well, it is desirable that a structure be adopted in which the first and second reel members 182 and 184 can be centered with high accuracy.

Meanwhile, although in the above respective embodiments, examples have been shown in which the first reel members 148, 172 and 182 are securely fixed to the second reel members 152, 174 and 184 respectively by use of a ultrasonic welding, the present invention is by no means limited thereto, and it is also possible that the first reel member 148 etc. may be securely fixed to the second reel member 152 etc. by means of adhesive, crimping or the like. Further, in the present invention, the material for the first reel member 148 and etc. and the second reel member 152 and etc. is not limited to plastic material, but for example, one or both of them may be formed from metallic material. In this case, it is preferable that the member on the side on which the hub 140 etc. is provided be formed from metallic material.

Further, although in the above respective embodiments, a preferred structure has been adopted in which the lower flange 142 and upper flange 144, formed integrally with the hub 140 or 162, are prevented from being displaced or deformed toward the magnetic tape T, while the hubs 140 and 162 are allowed to be deformed due to a winding pressure of the magnetic tape T, the present invention is by no means limited thereto and may adopt a high-strength (high-rigidity) structure for suppressing deformation of the hub 140 or 162 due to winding pressure, with, for example, carbon fiber or talc (plate-like filler) added to the plastic material which forms the hub 140 or 162. Since the second reel members 152 etc. are not fixed to the hub 140 or 162, the hub 140 or 162 can be constructed to have a high strength without taking into account the weldability or the like of the hub 140 etc. with respect to the second reel member

Further, although in the foregoing respective embodiments, examples have been shown in which the reels 10, 110, 160, 170, and 180 are applied to the recording tape cartridge 12 which is structured in a manner to accommodate a single reel in the case 14, the present invention is by no means limited thereto, and it is also possible that the reels 10, 110, 160, 170, and 180 may be applied to a recording tape cartridge which accommodates two reels in a case, for example.

While the present invention has been illustrated and described with respect to specific embodiments thereof, the present invention is not limited thereto but encompasses various changes and modifications which will become possible within the scope of the appended claims.

What is claimed is:

1. A reel comprising a hub on which a recording tape is wound, and a radially outwardly extending flange provided on an axial end portion of the hub, wherein the hub is formed in a tapered shape in which an end portion on the opposite side to the flange is larger in diameter than the flange side end portion, and wherein the hub has a taper angle given by:
θ<sin⁻¹(G/L)
where G is a spacing along an axial direction of the hub between the edge of the recording tape on the side opposite to the flange side end portion at a winding start end of the recording tape and the edge of the end portion of the hub opposite to the flange; and L is a winding length of the recording tape which is required to establish a state in which the recording tape can withstand a given tension when wound on the hub.

2. The reel according to claim 1, wherein: the hub includes a substantially cylindrical portion on which the recording tape is wound; and the substantially cylindrical portion is formed such that an upper end portion is greater in outer diameter than a lower end portion.

3. The reel according to claim 1, wherein: the hub includes a substantially cylindrical portion on which the recording tape is wound; and the substantially cylindrical portion is formed such that a lower end portion is greater in outer diameter than an upper end portion.

4. The reel according to claim 1, wherein the hub has a lower flange formed integrally therewith.

5. The reel according to claim 1, wherein the hub has an upper flange formed integrally therewith.

6. A reel comprising a hub on which a recording tape is wound between a pair of flanges provided in opposing relationship to each other, wherein the hub has a taper angle given by:
θ<sin⁻¹(G/L)
where G is a spacing along an axial direction of the hub between the edge of the recording tape on a larger-diameter end portion side of the hub at a winding start end of the recording tape and one of the flanges which is provided on the larger-diameter side of the hub; and L is a winding length of the recording tape which is required to establish a state in which the recording tape can withstand a given tension when wound on the hub.

7. A method of designing a reel comprising a hub on which a recording tape is wound, and a radially outwardly extending flange is provided on an axial end portion of the hub, wherein when the hub is structured in a tapered shape in which an end portion on the opposite side to the flange is larger in diameter than the flange side end portion, a taper angle of the hub is determined from:
θ<sin⁻¹(G/L)
where G is a spacing along an axial direction of the hub between the edge of the recording tape on the side opposite to the flange side end portion at a winding start end of the recording tape and the edge of the end portion of the hub on the side opposite to the flange; and L is a winding length of the recording tape which is required to establish a state in which the recording tape can withstand a given tension when wound on the hub.

8. A method of designing a reel comprising a hub on which a recording tape is wound between a pair of flanges provided in opposing relationship to each other, wherein when the hub is formed in a tapered shape, a taper angle of the hub is determined from:
θ<sin⁻¹(G/L)
where G is a spacing along an axial direction of the hub between the edge of the recording tape at a larger-diameter end portion of the hub at a winding start end of the recording tape with respect to the hub and one of the flanges which is provided on the larger-diameter side of the hub; and
L is a winding length of the recording tape which is required to establish a state in which the recording tape can withstand a given tension when wound on the hub.

9. A reel including a hub on which a recording tape is wound between a first and a second flange which are provided in opposing relationship to each other, the reel comprising:
a first member in which the first flange is integrally provided on an axial end portion of the hub; and
a second member in which the second flange is formed integrally with a fixed portion of the second member which is securely fixed to a portion other than the hub in the first member.

10. The reel according to claim 9, wherein the first member further comprises an extended portion which extends radially inward from an axial end portion of the hub; and the fixed portion of the second member is configured in the form of a cylindrical portion, which is contiguous with the second flange at one axial end thereof and secured to the extended portion of the first member at an opposite end thereof.

11. The reel according to claim 9, wherein the hub is formed to be open at an axial end portion opposite to the first flange, and in a tapered shape in which an outer diameter on the open end side is larger than an outer diameter on the first flange side.

12. The reel according to claim 10, wherein the hub is formed to be open at an axial end portion opposite to the first flange; and wherein the hub is formed in a tapered shape in which an outer diameter on the open end side is larger than an outer diameter on the first flange side.

13. The reel according to claim 9, wherein the hub is formed to be open at an axial end portion opposite to the first flange; and wherein the hub comprises a larger-diameter portion on which the recording tape is wound, and a smaller-diameter portion which is smaller in outer diameter than the larger-diameter portion and provided between the larger-diameter portion and the first flange.

14. The reel according to claim 10, wherein the hub is formed to be open at an axial end portion opposite to the first flange; and wherein the hub comprises a larger-diameter portion on which the recording tape is wound, and a smaller-diameter portion which is smaller in outer diameter than the larger-diameter portion and provided between the larger-diameter portion and the first flange.

15. A recording tape cartridge wherein a single reel as set forth in claim 1 is rotatably accommodated in a case.

16. A recording tape cartridge wherein a single reel as set forth in claim 6 is rotatably accommodated in a case.

17. A recording tape cartridge wherein a single reel as set forth in claim 9 is rotatably accommodated in a case.

18. A recording tape cartridge wherein two reels as set forth in claim 1 are rotatably accommodated in a case.

19. A recording tape cartridge wherein two reels as set forth in claim 6 are rotatably accommodated in a case.

20. A recording tape cartridge wherein two reels as set forth in claim 9 are rotatably accommodated in a case.
